(19) United States
(12) Patent Application Publication
(10) Pub. No.: US 2008/0071624 A1
(43) Pub. Date: Mar. 20, 2008

(54) Priority driven, ratings based, criteria considered and cost effective online selection of providers for events -- PRCC-EVENTS

(76) Inventor: Sarfaraz Alam Qureshi, Dublin, CA (US)

Correspondence Address: SARFARAZ ALAM QURESHI, 4370 FOXFORD WAY, DUBLIN, CA, 94568, US

(21) Appl. No.: 11/895,778

(22) Filed: Aug. 27, 2007

Related U.S. Application Data
(60) Provisional application No. 60/845,724, filed on Sep. 19, 2006.

(51) Int. Cl. G06Q 30/00

(52) U.S. Cl. 705/15

(57) ABSTRACT

This solution is an online automated solution of selecting the best value event need providers based on ratings and date priorities of event requestor, ratings and criteria of the event need providers which is also cost effective for the event requestor. This solution is called PRCC-EVENTS which stands for Priorities, Ratings, Criteria and Cost for Events. This technology draws all individuals or companies who have needs for their events and all individuals and companies who provide services, materials or accommodations for Events to this one single platform as a center point platform for the Events and Entertainment Industry. The requestor and provider's interface to this technology is Internet either via computers or handheld devices and telephone. Event requestor and providers will access this solution through Internet or via telephone. The Technologies used to develop this technology are combination of HTML, JSP, Java, J2EE, Java beans, API, Java serve-lets, JDBC, Applets, Microsoft front page and Dream weaver etc. This technology utilizes online Credit Card processing. This technology has three modules a—Requestor Module b—Provider Module c—Administrator Module

### CROSS_REFERENCE TO RELATED APPLICATION

This application claims the benefit of provisional application No. US60/845,724 with the priority date (filing date) of Sep. 19, 2006.

### BACKGROUND OF THE INVENTION

This technology provides an automatic online selection of event needs providers based on priorities of the requestor, ratings and criteria of the provider which is cost effective and affordable for the requester.

There are other solutions available where the solution simply connects event providers with the requestor of the event after collecting their requirements and are manual process where event providers or requestor contacts the other party where the rates of the provider's services, affordability of requester, priorities of the requestor and ratings of the provider are not accounted for in an automatically selecting process technology like this PRCC-EVENTS.

There is no solution available today where event requestor gets automatically matched with the event providers who are selected based on requestor's priorities which accounts for the ratings of the potential event providers, date priorities of the requestor and event criteria of the provider at the same time, event providers are cost effective and are affordable for the requestor.

This technology introduces a concept called “PRCC-EVENTS” (Priority driven, ratings based, criteria considered and cost effective selection of Event Need Providers for events). This technology finds an exact match for event requestor's needs based on their rating preferences, date preferences, provider's criteria and at the same time they are affordable. This technology is a central point platform for the Events and Entertainment Industry.

Here is the glossary of main terms:
Requestor or Event Requestor: Person who is requesting services for their Events
Provider or Event Need Provider: Restaurants, Caterers, Banquet Facilities, Specialty Food Stores, Deejays, photographers, videographers, cosmeticians, musicians and Bars who provide services for events.
Administrators: Internal employees who administer PRC-Events software
PRCC-Events: Priority driven, ratings based, criteria considered and cost effective selection of Event Need Providers for events

### BRIEF SUMMARY OF THE INVENTION

This technology introduces a concept called “PRCC-EVENTS” (Priority driven, ratings based, criteria considered and cost effective selection of Event Need Providers for events). This technology finds an exact match for event requestor's needs based on their rating preferences, date preferences, providers criteria and at the same time they are affordable for requestor. The requestors are not only getting the exact match for what they are looking for without driving or calling around, at the same time they get introduced to new possibilities for their events where they never imagined before. This technology is a central point platform for the Events and Entertainment Industry.

For example: Golf Course “A” has banquet facility which they are not marketing effectively or do not have constant marketing campaign to keep bringing event requesters, as a result, they do not have 100% utilization rate on the weekends. Then there is a requester “B” looking for banquet hall, “B” has no idea that golf course “A” even has a banquet facility or it even exists. With the help of this technology, golf course “A” will know about requestor “B's” request and gets connected on this center point platform technology.

### BRIEF DESCRIPTION OF THE SEVERAL VIEWS OF THE DRAWING

FIG. 1: Process Flow for Event Requestor (1/2)

This figure is a flow of how the requestor and corporate can engage into placing a request for Event Order. There are various different kinds of request they can create including for food catering like food catering delivery, Food catering pickup, Food catering Banquet Hall and On-going home food delivery. Also they can create request for Liquor Bar catering, event banquet Hall and Deejay Music Service providers. In the request they need to provide certain set of initial information as well as their three preferences in terms of dates and providers ratings. These three preferences and the criteria defined by the provider are responsible for finding the exact match for the requestor through this technology. This also triggers providers matching process that matches the providers that are best suited to be engaged.

FIG. 2: Process Flow for Event Requestor (2/2)

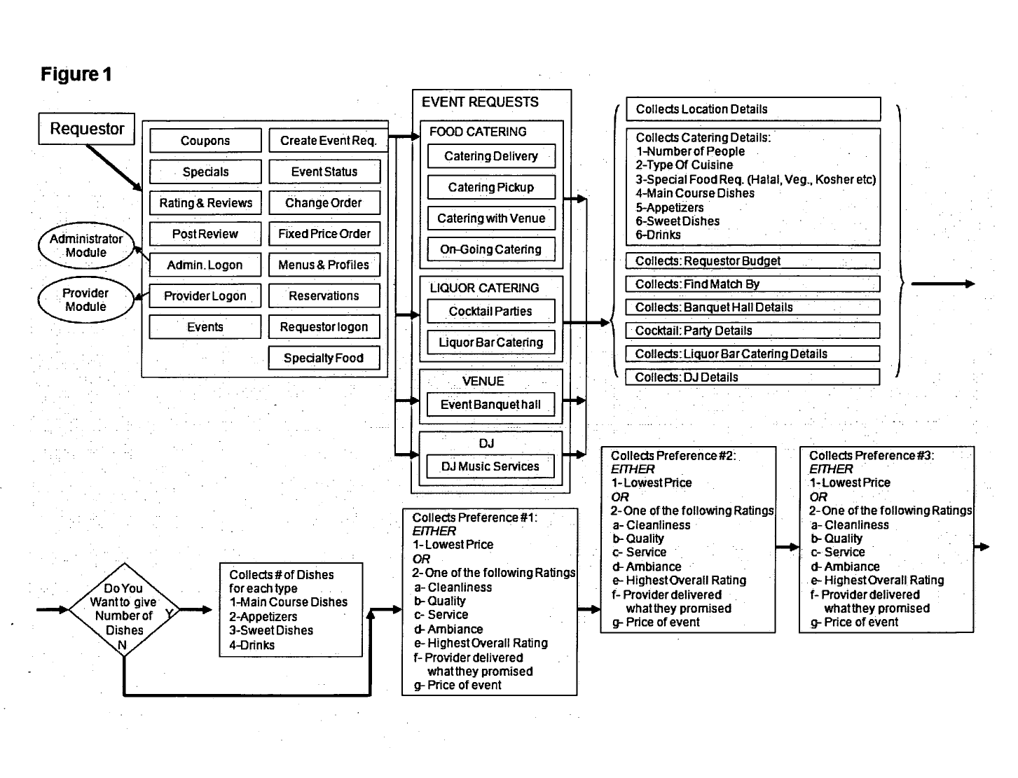

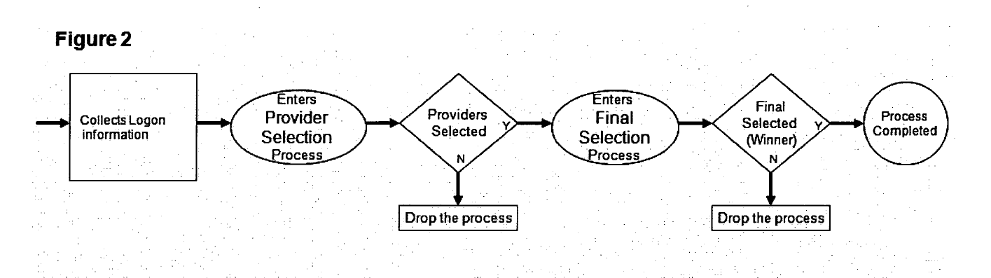

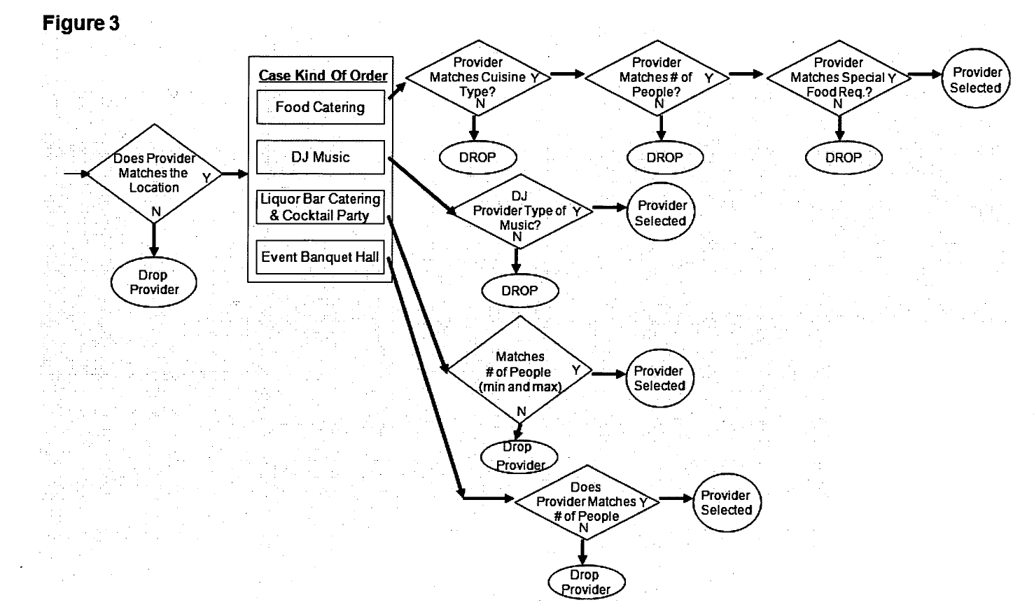

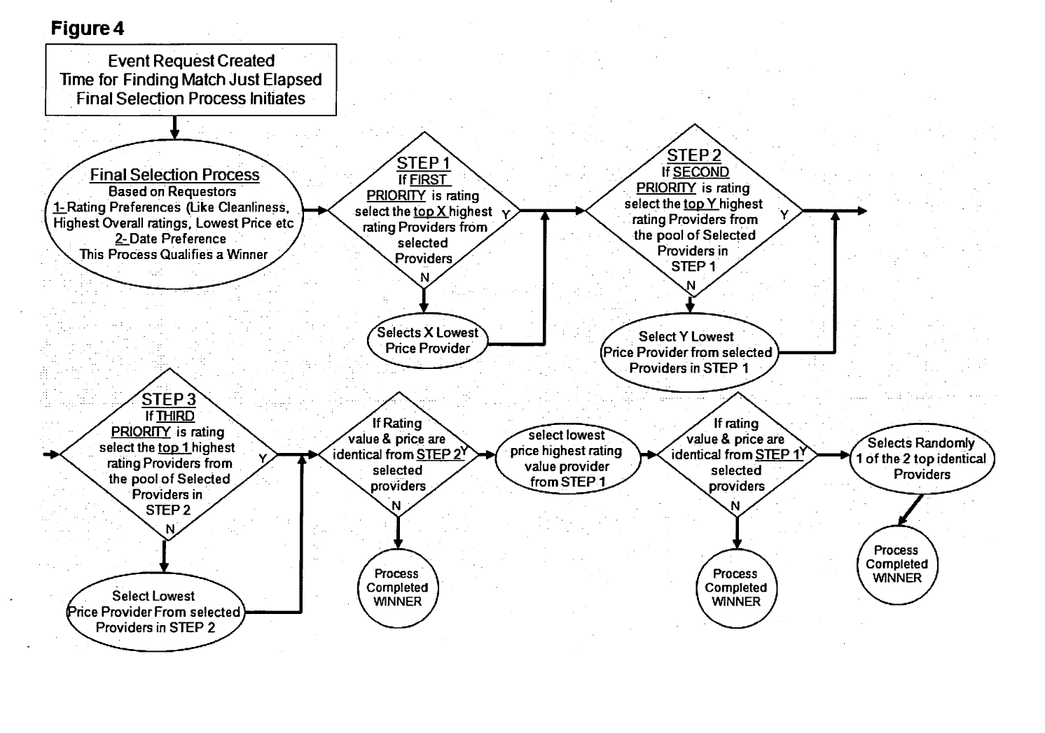

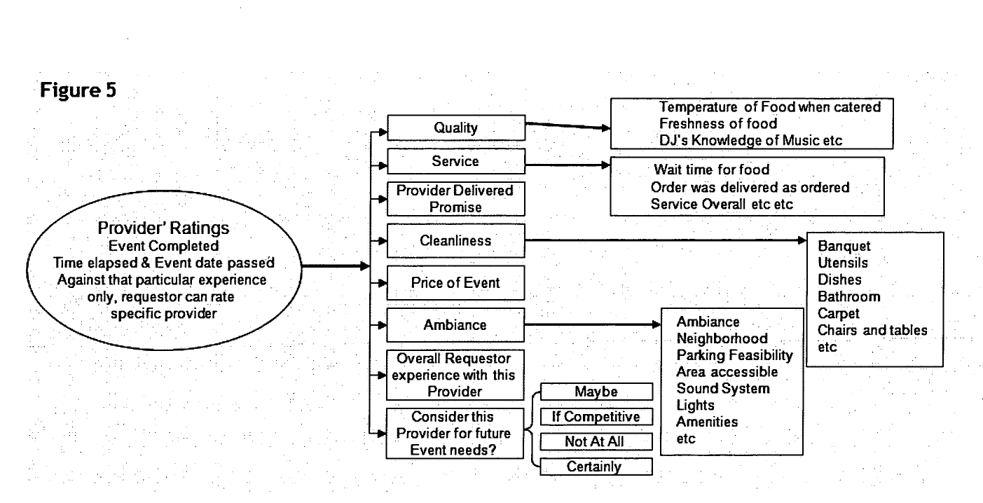

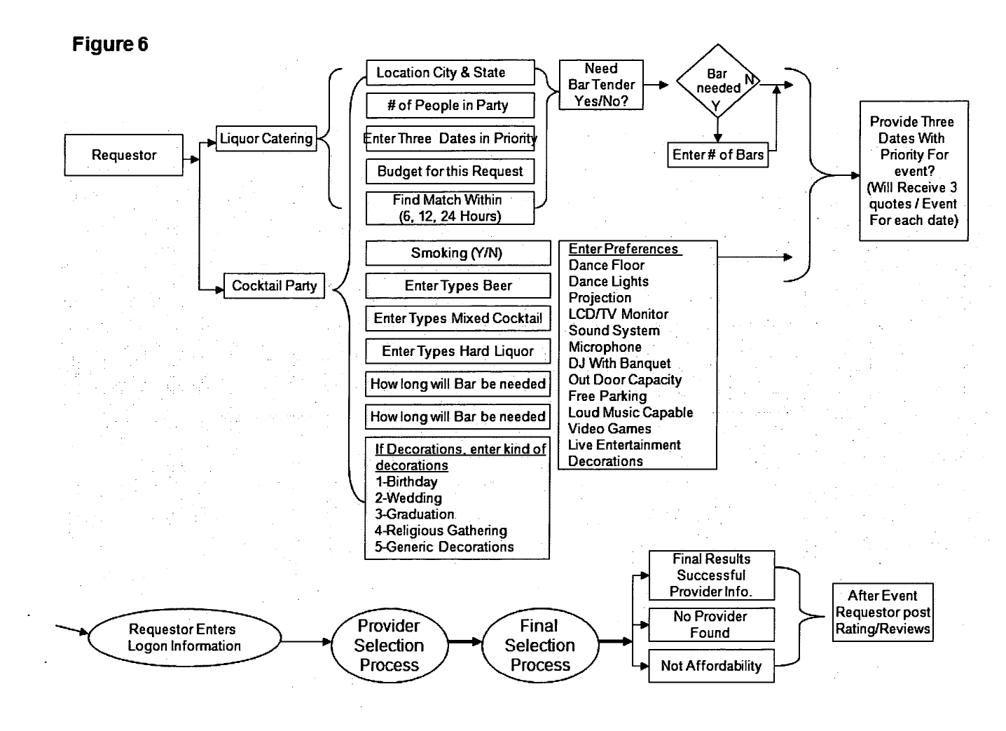

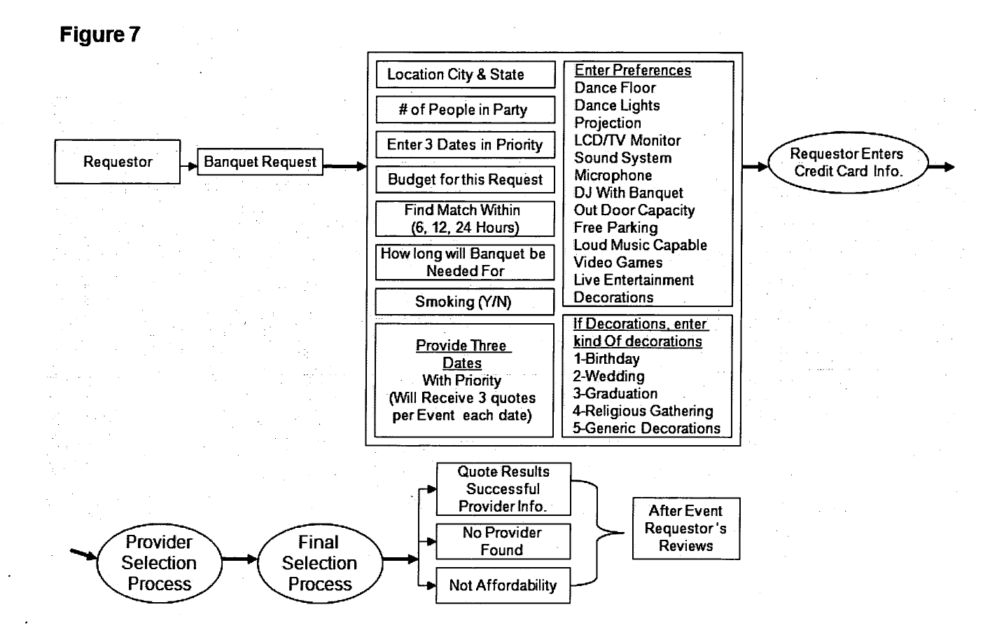

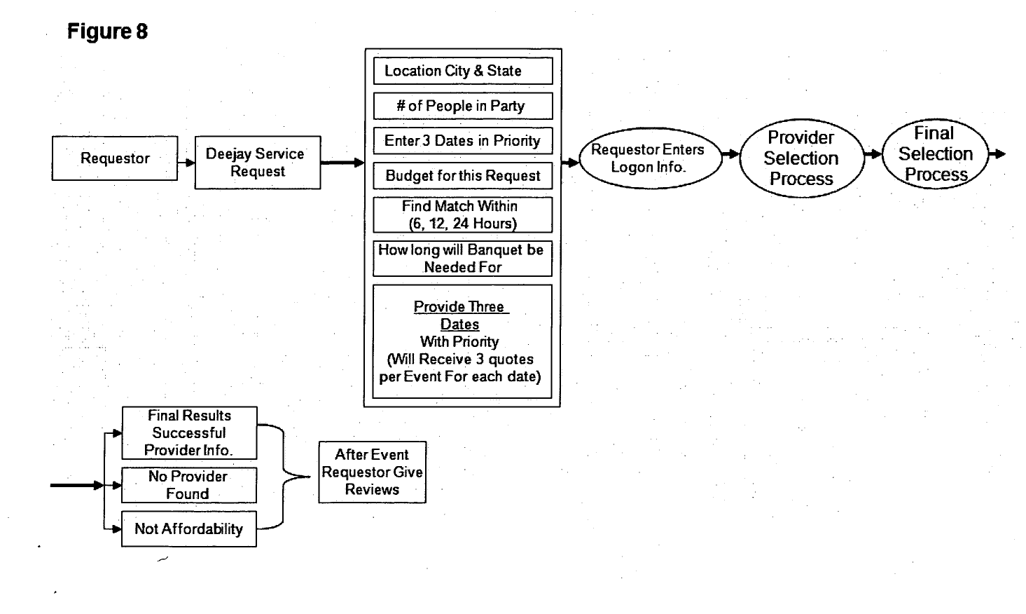

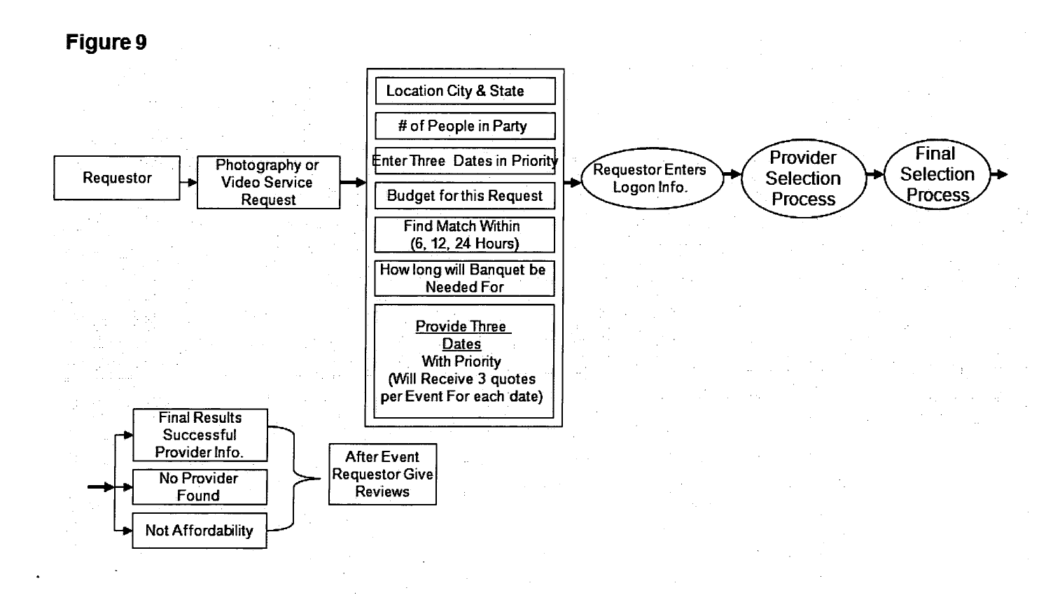

This figure shows the flow continued from FIG. 1. It shows Provider selection process and Final selection process after collecting requestor login details. This program is triggered when requestor creates a request. This process basically picks up all the parameters provided by requestors in terms of that they are looking for specifically kind of Cuisine, type of music, special food requirements, number of people and location etc and matches this with the information provided by each providers who are qualified in the same area where the requestor desires and qualifies Providers best suited for this request. Based on the providers selected by this service, the providers who were qualifies gets a page, email and notification in their accounts online that they have an opportunity for handling request for an event and sets up the alarm to wake up Final Selection process in the time to find match within parameter (6, 12, 24 hours) selected by Requestor.

FIG. 3: Provider's Selection Flow (based on Provider's preferences)

This figure shows the floe of Provider's selection process based on the criteria that the Provider provided. The process makes sure that if qualifies the right Providers who provide the requestor's desired type of cuisine, geographic location, type of music and number of guests in the event (minimum and maximum) etc.

FIG. 4: Provider's Selection Flow (based on Requestor's rating preferences)

This figure shows the flow of how Requestor's defined ratings are accounted for in selecting the right Provider for the request.

FIG. 5: Provider's Rating Flow

This figure shows Rating Process. Requestor can select their first, second and third preference in terms of lowest price, cleanliness, highest overall rating, quality, service, provider delivered promise, price of event and ambience.

FIG. 6: Process Flow for Liquor Catering or Cocktail Parties

This figure shows flow of process from Requestor initiating Liquor or Cocktail party Event Request to completion of the process

FIG. 7: Process Flow for Banquet Hall Requests

This figure shows flow of process from Requestor initiating Banquet Hall Event Request to completion of the process

FIG. 8: Process Flow for Deejay/Musician Requests

This figure shows flow of process from Requestor initiating Deejay or Musician Event Request to completion of the process

FIG. 9: Process Flow for Photography or Videography Requests

This figure shows flow of process from Requestor initiating Photography or Videography Event Request to completion of the process

### DETAILED DESCRIPTION OF THE INVENTION

The requestor and provider's interface to this technology is Internet either via computers or handheld devices (like cell phones and PDA's) and telephone. Requestor and Providers will access this solution through Internet or via telephone. The Technologies used to develop this technology are combination of HTML, JSP, Java, J2EE, Java beans, API, Java serve-lets, JDBC, Applets, Microsoft front page and Dream weaver etc. This technology utilizes online Credit Card processing.

This technology has three modules

1—Requestor Module.

2—Provider Module

3—Administrator Module

Requestor Module offers many options to requesters or requesters of this technology including but not limited to requestor creating a request for event, check status of their event request, requestor can order food online at fixed prices, requestor can create request for reservation online or get on a VIP list of an event or club, they can check public events happening in a particular area, search coupons and specials, they can check menus and ratings of a particular provider, requesters can post their reviews about the provider against their experience, they can read various magazine articles related to our providers or event's industry and requesters can see our nominated restaurant of the month. Requestors can also order specialty food products related to events or restaurants directly from manufacturers or product's sole distributors at wholesale or retail prices.

When requestor creates an Event request, they have option to either create a request called Event request for Food Catering Delivery for Event or Meeting, Food Catering pickup, Food catering with banquet hall, Regular home food delivery, cocktail party, liquor bar catering, Banquet Hall only and Deejay services provider. When requester are creating Event request, they are offered series of question includes location, number of people, type of cuisine, special food requirement (Vegetarian, Halal, Kosher, organic etc), Main course/appetizer/sweet dishes selection, drinks, number of dishes, delivery dates and times, spending limit and time for response, dance floor, dance lights, projection, LCD, TV, sound system, microphone, Deejay with banquet, out door capacity, free parking, smoking status, loud music capable, video games, live entertainment, decorations and kinds, delivery frequency, delivery days, preferred time, types of liquor, types of Beer/hard liquor/mixed cocktail, Bar tender with the liquor catering, Serving bar with the liquor catering, kind of music and length of time for event or Deejay services needs etc.

After requestor makes their initial selection or order, they select their preferences which are used by our software in selecting the right provider for their event. The Preferences are (not limited to):

Either Cost of the Event

1—Lowest price

Or Ratings

2—Highest overall Rating

3—Quality

4—Service

5—Delivered what provider promised

6—Cleanliness

7—Price of event

8—Ambience

Requestor can select their first, second and third preference in terms of lowest price, cleanliness, highest overall rating, quality, service, provider delivered promise, price of event and ambience etc. Requestor can also provide up to three dates in the order of their preference for the Event and preferred time of the day (morning, lunch, evening or all day event). This step uses our Provider Selection Process. After requestor selects their preferences this software system generates an Event Request Number. Based on requestor's preferences and then our software's Selection Process qualifies top three winning Provider for that particular event.

When an Event Request Number is generated, this triggers another system called Provider Selection process. This process uses the requestor's order criteria or needs and matches them against Provider's offerings in their profiles and qualifies the right providers who can potentially participate for a particular Event and sends them notifications with the inquiry created by the requestor for the event need.

Providers can choose to reply or ignore, if Provider replies to a particular event request, they need to offer their best competitive prices. The provider who is the lowest in price is not necessary the winner, this is only determined by. the preferences which were defined by the requester for the event at the time when they created the order which also accounts for provider's ratings that we collected against other past event experiences of requestors for specific selected providers and the date preferences of the requestors for that event and then our software finalizes the right provider.

After the Event request is completed and event has occurred, only then requestor can post their reviews about that particular experience with that specific provider in terms of price satisfaction, cleanliness, highest overall rating, quality, service, provider delivered promise and ambience. This posting of review is not anonymous and is based on a particular event. Only the requesters who have an experience with a particular provider through us can post their ratings against their past order number. This gives protection to Providers as well as it makes this rating system more reliable, accurate and un-temper able.

If Requestor checks Event Requests, requestor can see if they got responses and either we were able to find the right providers. Here requesters find out if their request was successful or failed due to their expectation for the Event not met amount or no one provides that particular service in their desired area. As soon as we find the right provider, we give three top options to requestor to select their one best value Provider.

Requestors are also able to request reservation directly from our website for the providers who participate in online reservations. This option gives requestors a reservation number which requesters can use to claim their reservation. Additionally, requesters can get on VIP lists of events or clubs and they can use our software generated guarantee number to claim their position.

Providers from their options page can view current Event requests in their area or the requests matching their service criteria. Here Providers can specify their price for a specific event. At that point if Provider's price for a specific event is lower than the requestor's expectation it rejects it otherwise it accepts it as potential provider for a particular event order.

Besides various other options, Providers can also view their current open requests and their statuses. Providers can also view their event request history that includes all the successful and un-successful event request responses for their track record.

Providers are also able to order or sell their specialty food directly through our software and website to other requesters or Providers at retail or wholesale prices based on quantity on one time or periodic basis. Administrators can also enter responses to Event Requests manually for providers

Administrators can also view all kinds of transactions like

1—All open transactions

2—Review all open transactions to date

3—Review all cancelled transactions to date etc

Administrators can also do financial activities from here, like:
Check revenue generated from monthly membership fee and if there were providers we were not able to collect fee from
Check revenue generated from transaction fees in correspondence to Request Order Number and Provider
Check revenue generated from membership setup fee and if there were providers we were not able to collect fee from
Cancelled orders and amount remittance to Providers and Requestors
Payment pending to provider, stop payment and to enforce payment
Manually charge provider on their credit card or credit provider
Send payments to provider or requestor
   1—Process: Generation of Event Request Number

When requestor creates an Event request, they have option to either create a request for

1—Food Catering Delivery for Event or Meeting or Airlines

2—Food Catering pickup

3—Food catering with banquet hall

4—Regular home food delivery

5—Cocktail party

6—Liquor bar catering

7—Banquet Hall

8—Deejay services provider

Etc

When requestor are creating Event request, they are offered series of question including but not limited to location, number of people, type of cuisine, special food requirement (Vegetarian, Halal, Kosher, organic etc), Main course/appetizer/sweet dishes selection, drinks, number of dishes, delivery dates and times, spending limit and time for response, dance floor, dance lights, projection, LCD, TV, sound system, microphone, Deejay with banquet, out door capacity, free parking, smoking status, loud music capable, video games, live entertainment, decorations and kinds, delivery frequency, delivery days, preferred time, types of liquor, types of Beer/hard liquor/mixed cocktail, Bar tender with the liquor catering, Serving bar with the liquor catering, kind of music and length of time for event or Deejay services needs etc.

After requestor makes their initial selection they select their Preference. The Preferences are not limited to Lowest Price, Highest Overall Rating, Quality, Service, Delivered What Provider promised, Cleanliness, Price of event or Ambience etc.

Requestor can select their first, second and third preference in terms of lowest price, cleanliness, highest overall rating, quality, service, provider delivered promise, price of event and ambience etc. Requestor can also provide up to three dates in the order of their preference for the Event and preferred time of the day (morning, lunch, evening or all day event). This step uses our Provider Selection Process. After requester selects their preferences this software system generates an Event Request Number. Based on requestor's preferences and then our software's Selection Process qualifies top three winning Provider for that particular event.

When an Event Request Number is generated, this triggers another system called Provider Selection process.

2—Process: Provider Selection

This process find providers who are best suited for handing a particular Event Request in terms of their locations, Cuisines Types, Number of people, special requirements like (Kosher, Halal, Vegetarian etc) and type of music.

3—Process: Final Selection

This process gets initiates based on requestor selected time frame. When this time is reached, Provider's opportunity to participate for that event is over; it does not allow any more provider to enter their price for the event. Then it takes the requestor's selected preferences either for Lowest Price or highest Priority in terms of Quality, Service, Promise delivery History, Cleanliness, Price of Event, Ambience and overall ratings and also considers the three date preferences that the requestor has provided as their preference for the event and finds the best matches of providers and informs both parties.

### EXAMPLE

Step 1:

If FIRST PRIORITY is one of the ratings, it selects the top X highest rating providers from the pool of Selected Providers. If it was Lowest Price, then it selects X lowest price offers from Providers

Step 2:

If SECOND PRIORITY is rating it selects the top Y highest rating providers from the pool of Selected Providers in STEP 1. If it was Lowest Price, then it selects Y lowest price offer Provider's from selected Providers in STEP 1

Step 3:

If THIRD PRIORITY is rating it select the top 3 highest rating provider from the pool of Selected Providers in STEP 2. If it was Lowest Price, then it selects 3 lowest price offer Provider's from selected Providers in STEP 2.

If Rating value and Price are identical from STEP 2 selected Providers. It selects lowest price or highest rating Providers from STEP 1.

Afterwards, if Rating value and price are identical from STEP 1 selected Providers. It randomly selects 3 top identical Providers.

At this point, our software connects both requestor and Providers on our event's online marketplace software.

What is claimed is:

1. My invention is an online automated solution of selecting the best value event need provider based on ratings and date priorities of event requestor, ratings and criteria of the event need providers which is also cost effective for the event requestor.

2. My invention is an automated solution of finding the best value event need's provider for events.

3. My invention draws all individuals or companies who have needs for their events and all individuals and companies who provide services, materials or accommodations for events to one single platform as a center point for the Events and Entertainment Industry.

4. My invention is an Events center point platform.

5. My invention brings all kinds of cuisine in food caterings, liquor caterings, on-going home food delivery, cocktail parties, banquet halls and deejay service providers to criteria meeting event requesters.

6. The method of claim 1, wherein said my Invention automatically qualifies event need providers not just on the basis of lowest price but also involves event requestor's defined preferences in terms of ratings of the provider and dates.

7. The method of claim 1, wherein has a method of provider qualification process where not all the providers in the area gets the event need request, instead it selects specific providers who meets the criteria in the needs of requestor for event before providers are even made aware of the request.

8. The method of claim 1, wherein requestor can post ratings against providers in a way where providers are protected against unjustified ratings.
